(19) United States
(12) Patent Application Publication
(10) Pub. No.: US 2008/0153556 A1
(43) Pub. Date: Jun. 26, 2008

(54) Wireless Ear-Phone and Portable Terminal Using the Same

(75) Inventor: Jae Duk Oh, Gyeonggi-do (KR)

Correspondence Address: RABIN & Berdo, PC, 1101 14TH STREET, NW, SUITE 500, WASHINGTON, DC, 20005, US

(73) Assignee: Openbrain Technologies Co., Ltd., Gyeonggi-do (KR)

(21) Appl. No.: 11/815,412

(22) PCT Filed: Mar. 15, 2006
(86) PCT No.: PCT/KR06/00922

§ 371 Date: Aug. 2, 2007

(30) Foreign Application Priority Data
Mar. 18, 2005 (KR) 10-2005-0022732

(51) Int. Cl. H04M 1/00; H04R 5/033

(52) U.S. Cl. 455/570; 381/311

(57) ABSTRACT

A wireless earphone includes: a wireless transmitting/receiving unit for transmitting/receiving a signal to/from the portable terminal according to a short wireless communication scheme; a voice detecting unit for detecting a user voice signal with being inserted into an ear of the user; a signal processing unit for converting a short range wireless communication signal received through the wireless transmitting/receiving unit to an audio signal, eliminating noise and echo from a voice signal received through the voice detecting unit, converting the noise and echo eliminated voice signal to a short range wireless communication signal and transmitting the short range wireless communication signal; an output unit for outputting the audio signal received from the signal processing unit; and a power supplying unit for receiving power and being charged when the wireless stereo earphone is attached to the mobile terminal, and supplying the power to each element of the wireless earphone.

### TECHNICAL FIELD

The present invention relates to a wireless ear-phone and a portable terminal using the same; and more particular, to a wireless stereo ear-phone and a portable terminal interacted with a wireless stereo ear-phone.

### BACKGROUND ART

A portable terminal denotes a terminal handy to carry such as a mobile communication terminal, a personal communication service (PCS) terminal, a personal digital assistant (PDA), a smart phone, a next generation mobile communication terminal, a wireless local area network (LAN) terminal, a digital multimedia broadcasting (DMB) terminal, a portable Internet terminal, a portable music reproducing device and a portable multimedia reproducing device.

A mobile communication terminal has been dramatically developed and such a development allows the mobile communication terminal to have various entertainment functions such as a game, a camera, a video player and a MP3 player as well as the communication function. Such a mobile communication terminal having various functions has been popular among users. Despite of dramatic development of the mobile communication terminal, there are still many researches in actively progress to develop mobile communication terminals to have functions of receiving a digital broadcasting, storing and reproducing multimedia files and video referencing function.

According to introduction of various functions for a mobile communication terminal, there were many peripheral devices developed and introduced in various shapes. For example, various peripheral devices connected to the mobile communication terminal through a universal serial bus (USB) port. Recently, a short range wireless communication technology such as Bluetooth technology is commonly used to connect a peripheral device to the mobile communication terminal,

Moreover, it is a current trend to integrate peripheral devices with the mobile communication terminal. For example, an external camera, an external MP3 player and a FM radio are integrally embedded into the mobile communication terminal for convenience to carry.

On the contrary, there is a peripheral device providing convenience when it is separated from the mobile communication terminal, for example, an input/output device. That is, an earphone or a headphone is generally used for reproducing multimedia files such as movie image files or reproducing music files. However, the user may have restrictions because the conventional earphone and headphone are connected to the mobile communication terminal through a cable.

In order to overcome such an inconvenience, a wireless earphone or a wireless headset were introduced in U.S. Patent Publication No. 2004/0141610 A1 (Jul. 22, 2004), U.S. Patent Publication No. 2005/0204155 A1 (Oct. 14, 2004), U.S. Pat. No. 6,021,207 A Feb. 1, 2000) and U.S. Pat. No. 6,230,019 B1 (May. 8, 2001).

Also, a wireless earphone inserted into a human ear was introduced in Japan Patent Application No. 2004-220147.

According to these conventional technologies, a short range wireless communication device such as a Bluetooth transmitting/receiving device embedded in a mobile communication terminal to transmit an audio signal to the wireless earphone through a wireless link.

However, a non-rechargeable battery or a rechargeable battery is used to supply a power and the rechargeable battery is generally embedded in the wireless earphone. In case of using the rechargeable battery, the wireless earphone or the wireless headset uses different power charging units which are separately provided from the mobile wireless communication terminal. A battery running time of the wireless earphone may be different from that of the mobile communication terminal. Therefore, the wireless headset may not be available to use since the battery thereof are all used.

Since the wireless headset is an independent device from the wireless communication terminal, a user carries the wireless headset, separately. So, there is a great chance to loss the wireless headset. Since the conventional wireless headset is generally designed to be wearable at one ear only, the conventional wireless headset cannot process a stereo audio signal. In a view of the current trend of demanding the multimedia functions of the wireless communication terminal, the users cannot satisfied with the conventional mono type earphone. Therefore, there are greater demands for a high quality stereo audio device.

The conventional headset is generally designed to have a right side speaker and a left side speaker or a right side earphone and a left side earphone, which are connected by a band. And, a circuit for providing a wireless headset function is embedded at one side of the conventional headset and a rechargeable batter is disposed at other side of the conventional headset. Such a design of the conventional headset makes the conventional headset difficult to be miniaturized and makes a user inconvenient to carry.

Meanwhile, a conventional wireless earphone that is rechargeable through connecting to a wireless communication terminal was introduced in Korea Patent Publication No. 1999-0046637 and Korea Patent Publication No. 2003-0064155.

Although these conventional technologies were introduced to overcome the shortcoming of the wired earphone, it is still difficult to miniaturize the wireless earphone or the wireless headset because a microphone must be disposed near to a mouth to guarantee a high speech quality. However, such a design makes the wireless headset to be miniaturized. On the contrary, if the microphone is disposed near to a speaker in order to miniaturize the wireless headset, the speed quality is degraded.

### DISCLOSURE OF INVENTION

### Technical Problem

It is, therefore, an object of the present invention to provide a wireless earphone attachable to a main body of a communication wireless terminal for transmitting/receiving a wireless communication signal to/from a mobile communication terminal by interacting with a mobile communication terminal while providing convenience a user to carry when the wireless earphone is not used.

It is another object of the present invention to provide a wireless communication terminal for transmitting and receiving a short range wireless communication signal to/from the wireless earphone by interacting with the wireless earphone and for housing and recharging the wireless earphone.

### Technical Solution

In accordance with one aspect of the present invention, there is a wireless stereo earphone attachable to a portable terminal including: a wireless transmitting receiving unit for transmitting/receiving a signal to/from the portable terminal according to a short wireless communication scheme; a voice detecting unit for detecting a user' voice signal with being inserted into an ear of the user; a signal processing unit for converting a short range wireless communication signal received through the wireless transmitting/receiving unit to an audio signal, eliminating noise and echo from a voice signal received through the voice detecting unit, converting the noise and echo eliminated voice signal to a short range wireless communication signal and transmitting the short range wireless communication signal; an output unit for outputting the audio signal received from the signal processing unit; and a power supplying unit for receiving power and being charged when the wireless stereo earphone is attached to the mobile terminal, and supplying the power to each element of the wireless earphone.

In accordance with another aspect of the present invention, there is provided a portable terminal with an attachable wireless stereo earphone, including: an attaching/detaching unit for attaching the wireless stereo earphone to the mobile terminal or detaching the wireless stereo earphone from the portable terminal, and charging the wireless earphone by connecting a rechargeable battery of the wireless earphone to a charging circuit of the portable terminal when the wireless stereo earphone is attached to the portable terminal; a controlling unit for connecting/disconnecting a wireless communication path between the wireless earphone and the portable terminal by sensing the wireless earphone to be attached or to be detached to/from the attaching/detaching unit, transmitting an audio signal to a short range wireless transmitting/receiving unit by sensing the wireless earphone to be separated from the attaching/detaching unit and converting a voice signal transmitted from the short range wireless transmitting/receiving unit to a wireless communication signal and radiating the wireless communication signal; and the short range wireless communication unit for connecting or disconnecting a wireless communication path between the wireless earphone and the portable terminal in response to the controlling unit, converting the audio signal received from the controlling unit to a short range wireless communication signal, outputting the short range wireless communication signal, and converting a short range wireless communication signal received from the wireless earphone to an audio signal.

### Advantageous Effects

A wireless earphone according to the present invention has a capability of transmitting/receiving a voice and an audio signal to/from a mobile communication terminal and has a shape of an earplug. Therefore, a user can conveniently communicate with a person on the other end of the communication ink, reproduce a multimedia file, receive a broadcast program of TV and have a video conference using the wireless earphone by putting the wireless earphone into the ears. Also, the wireless earphone is easy to carry by attaching the wireless earphone to the main body of the mobile communication terminal when it is not used. That is, the wireless earphone may be protected from being lost.

### BRIEF DESCRIPTION OF THE DRAWINGS

The above and other objects and features of the present invention will become apparent from the following description of the preferred embodiments given in conjunction with the accompanying drawings, in which:

FIG. 1 is a perspective view of a wireless earphone according to an embodiment of the present invention;

FIG. 2 is a front view illustrating a wireless earphone 100 attached or detached to/from a mobile communication terminal 200;

FIG. 3 is a side view of a mobile wireless terminal 200 with a wireless earphone 100 attached according to an embodiment of the present invention;

FIG. 4 is a cross-sectional view of a wireless earphone according to an embodiment of the present invention;

FIG. 5 is a block diagram illustrating a wireless earphone 100 according to an embodiment of the present invention;

FIG. 6 is a view showing a method of using a wireless earphone according to the present invention; and

FIG. 7 is a block diagram illustrating a mobile communication terminal having a wireless earphone according to the present invention.

### BEST MODE FOR CARRYING OUT THE INVENTION

Other objects and aspects of the invention will become apparent from the following description of the embodiments with reference to the accompanying drawings, which is set forth hereinafter.

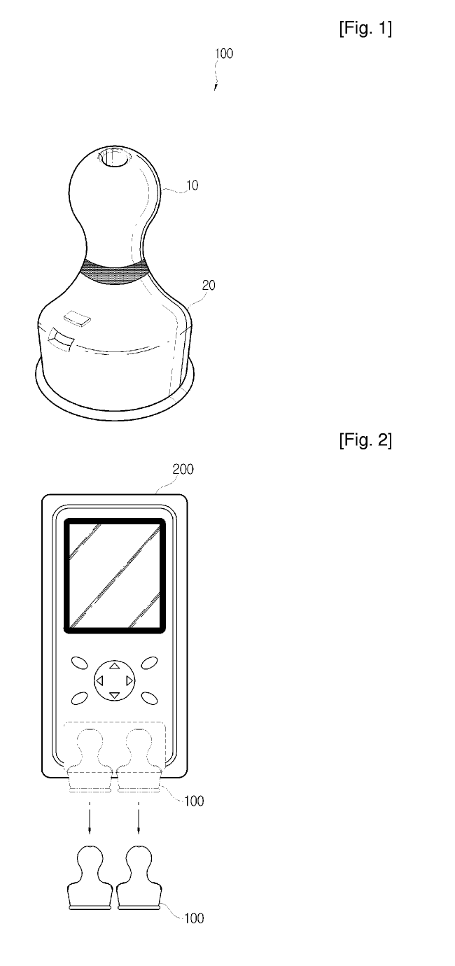

FIG. 1 is a perspective view of a wireless earphone according to an embodiment of the present invention.

As shown in FIG. 1, the wireless earphone 100 according to the present embodiment is shaped in an earplug, and includes an inserting unit 10 putted into an earhole of a user and a main body 20 connected to the inserting unit 10. The main body 20 includes an antenna, a battery, a speaker and a signal processing circuit for performing a wireless headset function.

The inserting unit 10 transmits and receives an audio signal to/from a wireless communication terminal though a wireless communication link when a user puts the inserting unit 10 into the his earhole and the wireless earphone 10 is in the active mode. Herein the audio signal denotes a stereo audio signal as well as a voice signal.

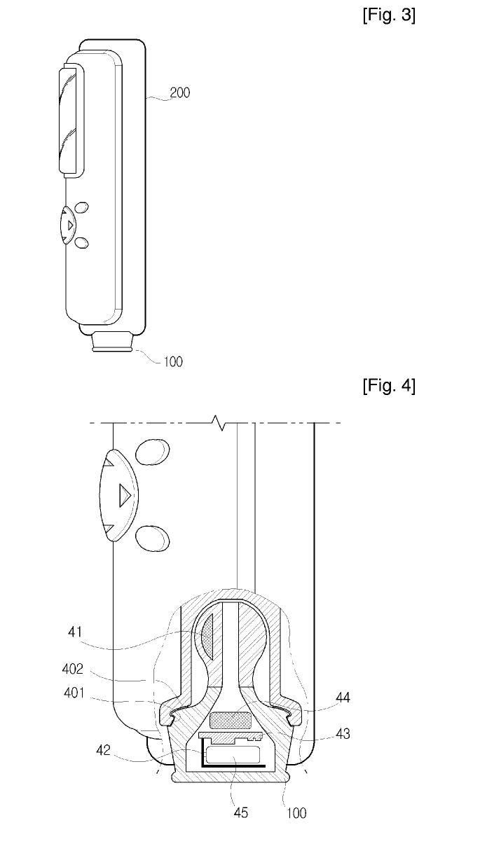

On contrary, if the wireless earphone 100 is not used, the wireless earphone 100 is attached to the main body of the mobile communication terminal as shown in FIGS. 2 and 3. FIG. 2 is a front view illustrating a wireless earphone 100 attached or detached to/from a mobile communication terminal 200, and FIG. 3 is a side view of a mobile wireless terminal 200 with a wireless earphone 100 attached according to an embodiment of the present invention.

The inserting unit 10 has a shape of curves to be comfortably inserted into an earhole of a user and is made of material having elasticity and smooth texture to provide comfortable wearing sensations. The inserting unit 10 includes a voice signal detecting unit such as a microphone or a voice detecting device from a user' bone. Accordingly, the inserting unit 10 has a shape and is made of a material to be closely adhered to the user' earhole in order to effectively detect the user' voice.

In order to attach the inserting unit 10 to the mobile communication terminal 200, a groove 401 formed on the wireless earphone 100 is connected to a mounting unit 201 formed on the mobile communication terminal 200. When the inserting unit 10 is attached to the mobile communication terminal 200 as shown in FIG. 4, a recharge contacting point 402 must be connected to a power supplying line (not shown) of the mobile communication terminal 200. Although the groove 41 and the recharge contacting point 402 are formed on the main body 20 of the wireless earphone according to the present embodiment shown in FIG. 4, the groove 41 and the recharge contacting point 402 may be formed various locations in other embodiments.

Hereinafter, the wireless earphone 100 according to the present invention will be described when the wireless earphone 100 is used for the wireless communication terminal 200 as an example. However, it is obvious that the wireless earphone 100 according to the present invention can be used to various devices having a short range wireless communication module such as a portable audio device, a communication device and a notebook computer. The short range wireless communication denotes a communication between various electronic devices to exchange data in a short range using an electric wave as a transmission medium of information. Most popular technologies for the short range wireless communication are a wireless local area network (LAN), a Bluetooth, a ZigBee, a HomeRF, an Ultra Wide Band (UWB). Such technologies replace a wired communication to a wireless communication in various fields to make a user convenient. Especially, the Bluetooth is commonly adopted into a mobile communication terminal to exchange information to peripheral devices.

Meanwhile, the inserting unit 10 includes a voice signal detector 41 such as a microphone or a sensor for detecting voice transmitted along a bone of a user. The conventional wireless headset or the conventional ear-set that is an earphone with a microphone generally use a microphone to receive the user' voice. In this case, the microphone is disposed near to the mouth to guarantee a high speed quality. Such a design makes it hard to miniaturize.

The wireless earphone 100 according to the present embodiment includes the voice signal detector 41 not far away from the speaker and is integrally embedded using a microphone or a sensor for detecting voice transmitted along a bone of a user. As a result, a volume thereof is reduced.

The main body 20 includes an antenna 42 for transmitting/receiving a short range wireless communication signal; a signal processing circuit 43 for converting a received short range wireless communication signal to an audio signal and outputting trough a speaker 44, and converting the received audio signal from a voice signal detector 41 to a short range wireless communication signal and transmitting the short range wireless communication signal through the antenna 42; a speaker 44 for receiving an audio signal from the signal processing circuit 43 and outputting the received audio signal; and a battery 45 for supplying electric power to elements included in the inserting unit 10 and the main body 20.

The battery 45 may be recharged trough a port (not shown) connectable to an external charger, or through a connector (not shown) of a mobile communication terminal 200 from a battery mounted at the mobile communication terminal 200. The mobile communication terminal 200 turns on/off the signal process circuit 43 by sensing the wireless earphone 100 to be attached or detached through the connector.

Hereinafter, the wireless earphone 100 according to the present invention will be described in detail.

FIG. 5 is a block diagram illustrating a wireless earphone 100 according to an embodiment of the present invention. FIG. 5 shows one of a right side unit and a left side unit of the wireless earphone 100 according to the present invention. A user puts the both side units of the wireless earphone on his ears to listen a stereo audio signal transmitted from the mobile communication terminal 200 or transmits his speech to a person on the other end of the communication line connected through the mobile communication network.

The right side unit and the left side unit of the wireless earphone 100 have a same hardware configuration and are distinguished by the mobile communication terminal 100 in software manner. That is, the wireless earphone 100 according to the present invention is different from the conventional stereo earphone having speakers with a fixed side. That is, the right side and the left side of the wireless earphone 100 according to the present invention are controlled in software manner. If a user losses or breaks one of side units of the wireless earphone 100, the user may purchase only lost or broken one for replacement. Therefore, the wireless earphone 100 according to the present invention has more economic benefit compared to the conventional earphone.

Although the wireless earphone 100 according to the present invention is designed to output a stereo audio signal, the wireless earphone 100 according to the present invention may output a mono audio signal using one of the right side unit and the left side unit, only. It is possible because the left side unit and the right side unit of the wireless earphone 100 independently have a speaker and an voice detecting unit.

Meanwhile, an echo may be created at an audio signal transmitted to a person on the other end of the communication line because the voice detecting unit is located near to the speaker when the user use the wireless earphone 100 to call.

In order to overcome such a shortcoming, an echo eliminating circuit using a digital signal processor (DSP) may be included. Generally, the echo eliminating circuit memorizes a received audio signal, determines whether the received audios signal is mixed with a transmitting audio signal, and eliminates the mixed signal. Various echo eliminating technologies were introduced and are well-known to those skilled in the art. Therefore, details thereof are omitted

As one of methods of eliminating the echo, the wireless earphone according to the present invention determines whether both of the left side unit and the right side unit of the wireless earphone 100 are connected to the mobile communication terminal 200 when the mobile communication terminal 200 is in a voice communication mode. If both of the side units are connected, a speaker included in one of the side units is activated and a voice signal detecting unit therein is inactivated on the contrary, a speaker and an voice detecting unit in other side unit of the earphone are inactivated.

As shown in FIG. 5, the wireless earphone 100 includes an antenna 42, a signal processing circuit 43, a speaker 44, a voice detecting unit 41 and a battery 45.

The antenna 42 receives a signal transmitted from a mobile communication terminal 200 based on short range wireless communication scheme, and transmits a short range wireless communication signal generated from the signal processing circuit 43.

The speaker 44 outputs an audio signal received from the signal processing circuit 43. The audio signal outputted through the speaker 41 may be a voice signal of a person on the other end of the communication link or a stereo audio signal reproduced from the mobile communication terminal 200.

The voice detecting unit 41 detects a voice signal of a user from a vibration of air in the earhole or from a skin or a bone.

The battery 45 includes a charging circuit 509 and a rechargeable battery 510. The charging circuit 509 receives power from a connector 402 connected to the mobile communication terminal 200, charges the rechargeable battery 510 and supplies the power in the rechargeable battery 510 to elements of the wireless earphone, uniformly.

The signal processing circuit 43 converts a short range wireless communication signal received through an antenna 42 to an audio signal and outputs the audio signal through the speaker 44. The signal processing circuit 43 also eliminates noise or echo from an audio signal received from the voice detecting unit 41, converts the audio signal to a short range wireless communication signal and transmits the short range wireless communication signal through the antenna 42.

The signal processing circuit 43 includes a radio frequency (RF) transmitting receiving circuit 501; a baseband processing circuit 502, an echo/noise eliminating circuit 503, an audio reproducing circuit 504, an analogue-digital converter 505, a digital-analogue converter 506, an input amplifier 507 and an output amplifier 508.

The RF transmitting/receiving circuit 501 amplifies, filters and convents a short range wireless communication signal received through an antenna to a wired signal and transmits the wired signal to a baseband processing circuit 52. Also, the RF transmitting/receiving circuit 501 converts the wired signal transmitted from the baseband processing circuit 502 to a short range communication signal and transmits the short range communication signal through the antenna 42.

The baseband processing circuit 502 demodulates the signal received from the RE transmitting/receiving circuit 501 and transmits the demodulated signal to the audio reproducing circuit 504. The baseband processing circuit 502 also receives the voice signal transmitted from the echo/noise eliminating circuit 503 and transmits the voice signal to the R transmitting and receiving circuit 501. Herein, the signal transmitted to the audio reproducing circuit 504 is a compressed stereo audio signal or voice sign.

The audio reproducing circuit 504 decompresses the compressed stereo audio signal or voice signal transmitted from the baseband processing circuit 502.

The digital-analog converter 506 receives the decompressed stereo audio signal or voice signal from the audio reproducing circuit 504 and converts the received signal to an analog signal.

The output amplifier 508 amplifies an analog signal transmitted from the digital-analog converter 506 and outputs the amplified analog signal through the speaker 44.

The input amplifier 507 amplifies a voice signal transmitted from the voice signal detecting unit 41.

The analog-digital converter 505 converts an analog voice signal transmitted throu gh the input amplifier 507 to a digital signal.

The echo/noise eliminating circuit 503 eliminates noise and echo from the voice signal received from the analog-digital converter 505.

Hereinafter, a mobile communication terminal having a wireless earphone according to the present invention will be described.

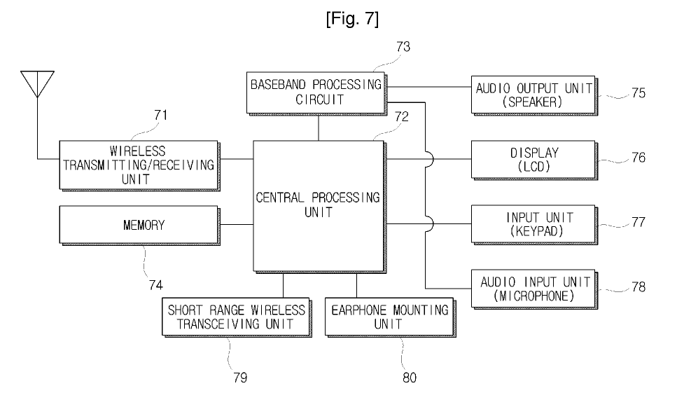

FIG. 7 is a block diagram illustrating a mobile communication terminal having a wireless earphone according to the present invention.

As shown in FIG. 7, the mobile communication terminal includes a wireless transmitting/receiving unit 71, a central processing unit (MSM) 72, a CODEC 73, a memory 74, a audio output device (speaker) 75, a display (LCD) 76, an input device (keypad) 77, an voice input unit (microphone) 78, a short range wireless transceiver 71 and an earphone mounting unit 880.

The wireless transmitting/receiving unit 71 transmits/receives a signal to/from a base station through an antenna. The signal transmitted through the wireless transmitting/receiving unit 71 is transmitted to other person s mobile communication terminal connected through the base station and a mobile communication network.

The central processing unit (MSM) 72 generally controls and drives the mobile communication terminal 200. Especially, the MSM 72 establishes a wireless communication link between the short range wireless transceiver 79 and the wireless earphone 100 when the MSM 72 senses the wireless earphone 100 to be detached from the earphone mounting unit 80. Then, the MSM 72 controls related elements to transmit an audio signal to be outputted through the audio output unit (Speaker) 75 to the short range wireless transceiver 79. The audio signal to be outputted may include an audio signal received through the wireless transmitting/receiving unit 71 such as a speech voice signal or a stereo audio signal and a stereo audio signal reproduced from the MSM 72. The short range wireless transceiving unit 79 converts the audio signal transmitted from the MSM 72 to a short range wireless communication signal and transmits the short range wireless communication signal through the antenna.

The stereo audio signal or the voice signal is compressed before it is transmitted to the short range wireless transceiver 79. Herein, both of a left audio signal and a right audio signal may be compressed together or they are independently compressed and transmitted to the short range wireless transceiver 79. When they are independently compressed, a left audio signal is transmitted to a left side unit of the wireless earphone and a right audio signal is transmitted to a right side unit of the wireless earphone.

The antenna may be embodied as one antenna to process two bands. However, two antennas may be included to process two bands, separately.

The MSM 72 converts an audio signal received from the wireless earphone 100 through the short range wireless transceiver 79 to a wireless communication signal and transmits the wireless communication signal through the wireless transceiver 71 and the antenna.

The short range wireless transceiver 79 connects or disconnects a wireless communication path to the wireless earphone 100 in response to the control of the MSM 72. Also, the short range wireless transceiver 79 converts an audio signal from the MSM 72 to a short range wireless communication signal and transmits the short range wireless communication signal to the wireless earphone 100. Furthermore, the short rage wireless transceiver 79 converts the short range wireless communication signal received from the wireless earphone 100 to an audio signal and transmits the audio signal to the MSM 73 in order to transmit the audio signal trough the wireless transmitting/receiving unit 71.

The short range wireless communication signal received from the wireless earphone 100 is a voice of a user, Generally, it is a signal input through a voice input unit 78 such as a microphone. Meanwhile, the wireless communication signal transmitted by the mobile communication terminal 200 through the antenna is transmitted to a mobile communication terminal of a person on the other end of the communication line through the base station and the mobile communication network.

The MSM 72 charges the wireless earphone 100 through a charge connecting point 402 which connects the wireless earphone 100 and the earphone mounting unit 80 when the wireless earphone 100 is attached to the mobile communication terminal. In order to control charging of the wireless earphone 100, a charging control circuit may be further included. Also, a light emitting diode (LED) may be included to represent a state of charging.

The CODEC 73 converts a digital audio signal from the wireless transmitting receiving unit 71 to an analog audio signal and outputs the analog audio signal through the audio output unit or transmits to the short range wireless transceiver 79 in response to a control of the MSM 72. Also, the CODEC 73 converts the analog audio signal inputted through the audio input device 78 to a digital audio signal and transits the digital audio signal to the MSM 72 in order to transmit through the wireless transmitting/receiving unit 71.

The memory 74 stores a file system with images, characters and icons, an address book, short messages, music files and moving image files.

The audio output unit (speaker) 75 outputs the analog audio signal received from the CODEC 73. The audio input unit 78 receives an analog audio signal and transmits the received signal to the CODEC 73.

The display (LCD) 76 displays information in response to the control of the MSM 72.

The input device (keypad) 77 receives a menu selection signal or a telephone number through buttons.

The wireless earphone 100 is attached in the earphone mounting unit 80 by external force that inserts the wireless earphone 100 into the earphone mounting unit 80 and the earphone mounting unit 80 holds the wireless earphone 100. Also, the earphone mounting unit 80 releases the wireless earphone 100 by the external force that pulls the wireless earphone 100 attached at the earphone mounting unit 80. The earphone mounting unit 80 is designed to release the wireless earphone when the earphone mounting unit 80 receives the external force greater than a predetermined threshold value in order to prevent the wireless earphone from being easily separated from the mounting unit 80.

The earphone mounting unit 80 connects the charge connecting point 402 to a power supply line (not shown) of the mobile communication terminal to charge the wireless earphone 100 when the wireless earphone is attached to the mobile communication terminal. Herein, the charging circuit 509 may be included in the wireless earphone device 100 according to the present embodiment However, the charging circuit 509 may be included in a mobile communication terminal according to another embodiment of the present invention.

Hereinafter, operations of the wireless earphone 100 according to the present invention will be described with an example case of a mobile communication terminal 200 is connected to other mobile communication terminal.

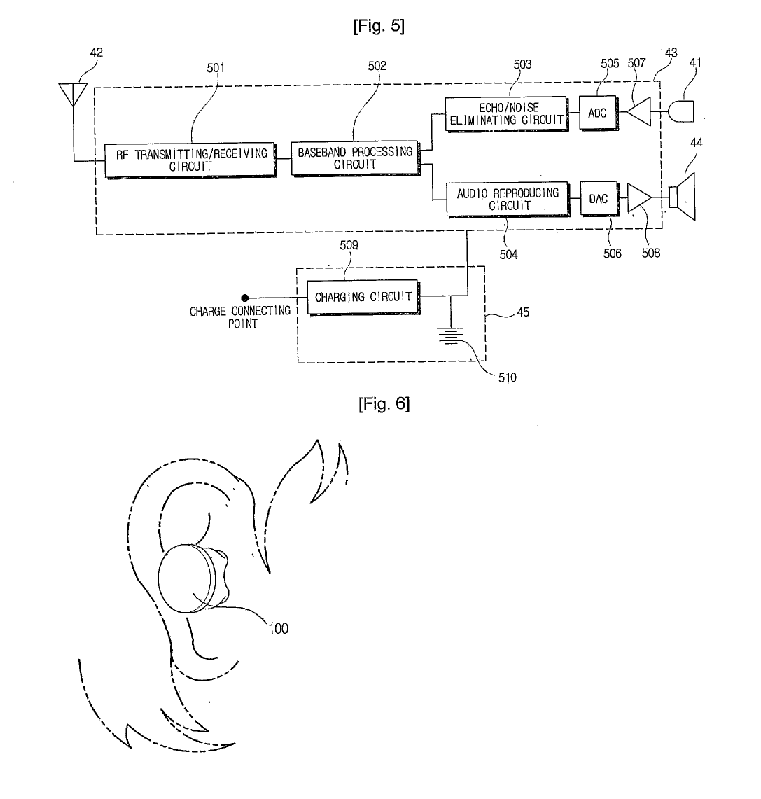

When a mobile communication terminal 200 with a wireless earphone 100 mounted receives a call from other mobile communication terminal, the wireless earphone 100 is separated from the mobile communication terminal 200 and the inserting unit 10 is inserted and fixed into the ear of the user as shown in FIG. 6. Herein, if the wireless earphone 100 is separated from the mobile communication terminal 200, a wireless communication path is established between the wireless earphone 100 and the mobile communication terminal 200. Accordingly, a user can listen music or a speech using the wireless earphone.

The wireless earphone 100 receives a speech signal of a person on the other end of the line which is received from the mobile communication terminal 200 through the antenna 42, processes the received signal through the RF transmitting/receiving circuit 501 and modulates the process signal in the baseband processing circuit 502. Then, the audio reproducing circuit 504 decompresses the modulate signal. If the mobile communication terminal 200 transmits a stereo audio signal having a left audio signal and a right audio signal, the audio reproducing circuit 504 selectively transmits the decompressed signal to the digital-analog converter 506 at the corresponding side.

If the mobile communication terminal 200 transmits the audio signal by separating the left audio signal and the right audio signal, the RF transmitting/receiving circuit 501 of the wireless earphone 100 selectively receives the corresponding one of the left audio signal and the right audio signal. Therefore, the audio reproducing circuit 504 transmits the decompressed signal to the digital-analog converter 506 without selecting a direction.

Then, the digital-analog converter 506 converts the digital audio signal to the analog audio signal and the analog audio signal is outputted through the speaker 44.

The wireless earphone 100 also performs following voice transmitting operations as well as the voice receiving steps described above.

At first, if a user makes a speech, the voice detecting unit 41 detects a voice signal, which is inserted into the earhole and adhered on the skin of the user. Then, the detected voice signal is transmitted to the analog-digital converter 507. The voice signal is converted to a digital signal at the analog-digital converter 507 and inputted into the echo/noise eliminating circuit 503.

The echo/noise eliminating circuit 503 eliminates noise included in the digital voice signal and eliminates echo signal inputted from the speaker 44. After eliminating the noise and the echo, the digital audio signal is modulated to a baseband signal and radiated through the RF transmitting/receiving circuit 501 and the antenna 41.

While the present invention has been described with respect to certain preferred embodiments, it will be apparent to those skilled in the art that various changes and modifications may be made without departing from the scope of the invention as defined in the following claims.

1. A wireless stereo earphone attachable to a portable terminal comprising:
a wireless transmitting/receiving means for transmitting/receiving a signal to/from the portable terminal according to a short wireless communication scheme; a voice detecting means for detecting a user' voice signal with being inserted into an ear of the user;
a signal processing means for converting a short range wireless communication signal received through the wireless transmitting/receiving means to an audio signal, eliminating noise and echo from a voice signal received through the voice detecting means, converting the noise and echo eliminated voice signal to a short range wireless communication signal and transmitting the short range wireless communication signal;
an output means for outputting the audio signal received from the signal processing means; and
a power supplying means for receiving power and being charged when the wireless stereo earphone is attached to the mobile terminal, and supplying the power to each element of the wireless earphone.

2. The wireless stereo earphone of claim 1, wherein the wireless transmitting/receiving means, the signal processing means, the output means and the power supping mean are included in a main body and the voice detecting means is included in an inserting unit which formed to be projected from the main body, wherein the inserting unit is inserted into the ear of the user.

3. The wireless stereo earphone of claim 2, wherein the wireless earphone includes a mounting means for attaching or detaching the wireless earphone to/from the mobile communication terminal.

4. The wireless stereo earphone of claim 2, further comprising a charge connecting means for connecting the power supply means to a power supplying line of the portable terminal when the wireless stereo earphone is attached to the portable terminal.

5. The wireless stereo earphone of claim 4, wherein the wireless transmitting/receiving means transmits and receives Bluetooth signals by interacting with the portable terminal.

6. The wireless stereo earphone of claim 1, wherein the wireless transmitting/receiving means is an antenna; and wherein the signal processing means includes:
a wireless processing means for converting a short range wireless communication signal received through the antenna to a baseband signal, converting the baseband signal received from the baseband processing means to a short range wireless communication signal and radiates the short range wireless communication signal through the antenna;
a baseband processing means for demodulating a signal received from the wireless processing means and modulating a signal received from an echo/noise eliminating means;
a decompressing means for decompressing a compressed audio signal received from the baseband processing means;
a digital-analog converting means for converting a digital signal received from the decompressing means to an analog audio signal;
an output amplifying means for amplifying an audio signal transmitted from the digital-analog converting means and transmitting the amplified audio signal to the output means;
an input amplifying means for amplifying an audio signal transmitted from the audio signal amplifying means;
an analog-digital converting means for converting an analog audio signal transmitted through the input amplifying means to a digital signal; and an echo/noise eliminating means for eliminating noise and echo from a signal received through the analog-digital converting means.

7. The wireless stereo earphone of claim 6, wherein the wireless processing means receives a stereo audio signal that is divided into a left audio signal and a right audio signal and transmitted independently through the antenna and outputs the received signal.

8. The wireless stereo earphone of claim 6, wherein the decompressing means receives the compressed stereo audio signal from the baseband processing means, decompressing the received audio signal and transmitting predetermined one of a right audio signal and a left audio signal to the digital-analog converting means.

9. A portable terminal with an attachable wireless stereo earphone, comprising:
an attaching/detaching means for attaching the wireless stereo earphone to the mobile terminal or detaching the wireless stereo earphone from the portable terminal, and charging the wireless earphone by connecting a rechargeable battery of the wireless earphone to a charging circuit of the portable terminal when the wireless stereo earphone is attached to the portable terminal; a controlling means for connecting/disconnecting a wireless communication path between the wireless earphone and the portable terminal by sensing the wireless earphone to be attached or to be detached to/from the attaching/detaching means, transmitting an audio signal to a short range wireless transmitting/receiving means by sensing the wireless earphone to be separated from the attaching/detaching means and converting a voice signal transmitted from the short range wireless transmitting/receiving means to a wireless communication signal and radiating the wireless communication signal, and
the short range wireless communication means for connecting or disconnecting a wireless communication path between the wireless earphone and the portable terminal in response to the controlling means, converting the audio signal received from the controlling means to a short range wireless communication signal, outputting the short range wireless communication signal, and converting a short range wireless communication signal received from the wireless earphone to an audio signal.

10. The portable terminal of claim 9, wherein the controlling means charges the rechargeable battery of the wireless earphone by supplying power to the wireless earphone when the controlling means senses the wireless earphone attached at the portable terminal.

11. The portable terminal of claim 9, wherein the audio signal transmitted from the controlling means to the short range wireless transmitting/receiving means is a voice signal of a person on the other end of the communication line which is transmitted through a base station in a voice communication mode.

12. The portable terminal of claim 11, wherein the controlling means determines whether a left side unit and a right side unit of the wireless earphone are connected in a voice communication mode, activates the output means and inactivates the voice detecting means included in one of the left side unit and the right side unit if both of the left side unit and the right side unit are connected, and inactivate an output means and a voice signal detecting means in another.

13. The portable terminal of claim 9, wherein the audio signal transmitted from the controlling means to the short range wireless transmitting/receiving means is a stereo audio signal reproduced at the controlling means.

14. The portable terminal of claim 13, wherein the attaching/detaching means attaches or detaches the wireless stereo earphone having a set of a right side unit outputting a right audio signal and a left side unit outputting a left audio signal.

15. The portable terminal of claim 14, wherein the controlling means compresses a left audio signal and a right audio signal together and transmits the compressed signal to the short range wireless transmitting/receiving means.

16. The portable terminal of claim 14, wherein the controlling means distinguishes the left side unit and the right side unit by an identification number,

17. The portable terminal of claim 16, wherein the controlling means compresses a left audio signal and a right audio signal separately, transmits the left audio signal to the left side unit and transmits the right audio signal to the right side unit.

18. The wireless stereo earphone of claim 3, wherein the wireless transmitting/receiving means transmits and receives Bluetooth signals by interacting with the portable terminal.

19. The wireless stereo earphone of claim 2, wherein the wireless transmitting/receiving means transmits and receives Bluetooth signals by interacting with the portable terminal.

20. The wireless stereo earphone of claim 1, wherein the wireless transmitting/receiving means transmits and receives Bluetooth signals by interacting with the portable terminal.
